(19) United States
(12) Patent Application Publication
(10) Pub. No.: US 2020/0310718 A1
(43) Pub. Date: Oct. 1, 2020

(54) PRINTER DRIVER AND RECORDING MEDIUM

(71) Applicant: Oki Data Corporation, Tokyo (JP)

(72) Inventor: Ryoichi OONAMI, Tokyo (JP)

(21) Appl. No.: 16/820,008

(22) Filed: Mar. 16, 2020

(30) Foreign Application Priority Data
Mar. 28, 2019 (JP) 2019-064429

(51) Int. Cl. G06F 3/12

(52) U.S. Cl. CPC G06F 3/1257; G06F 3/1204

(57) ABSTRACT

A printer driver causes a processor to perform a registration process in which correspondence information is generated by registering each of multiple preset informations in association with a file attribute information, an acquisition process in which a first file attribute information of a print target file, which is opened by an application software that is being executed, is acquired; and a display control process in which a control is performed such that, based on the first file attribute information and the correspondence information, one or more preset informations among the multiple preset informations are displayed in an easy-to-select display form.

### TECHNICAL FIELD

The present invention relates to a printer driver that performs print setting and generates print data, and relates to a recording medium that records such a printer driver.

### BACKGROUND

In an image forming apparatus, there are various print setting items, and an image is formed on a print medium such as a sheet of paper based on setting values of the print setting items. There is a printer driver capable of storing setting values of various print setting items (for example, Patent Document 1).

### RELATED ART

[Patent Doc. 1] JP Laid-Open Patent Application Publication 2010-097454

In print setting of a printer driver, in general, high user convenience is desired, and further improvement in user convenience is expected.

It is desirable to provide a printer driver and a recording medium that allow user convenience to be improved.

### SUMMARY

A printer driver, which is one embodiment of the invention, causes a processor to perform a registration process in which correspondence information is generated by registering each of multiple preset informations in association with a file attribute information, an acquisition process in which a first file attribute information of a print target file, which is opened by an application software that is being executed, is acquired; and a display control process in which a control is performed such that, based on the first file attribute information and the correspondence information, one or more preset informations among the multiple preset informations are displayed in an easy-to-select display form.

Another embodiment of the invention is a recording medium on which a printer driver is recorded. The printer driver causes a processor to perform: a registration process in which correspondence information is generated by registering each of multiple preset informations in association with a file attribute information; an acquisition process in which a first file attribute information of a print target file, which is opened by an application software that is being executed, is acquired; and a display control process in which a control is performed such that, based on the first file attribute information and the correspondence information, one or more preset informations among the multiple preset informations are displayed in a selectable display form.

According to the printer driver and the recording medium of an embodiment of the present invention, correspondence information is generated by registering each of multiple preset informations in association with a file attribute information; a first file attribute information of a print target file opened by an application software that is being executed is acquired; and control is performed such that, based on the first file attribute information and the correspondence information, one or more preset informations among the multiple preset informations included in the correspondence information are displayed in an easy-to-select display form. Therefore, user convenience can be improved.

### BRIEF DESCRIPTION OF THE DRAWINGS

FIG. 1 is a block diagram illustrating a configuration example of an image forming system according to an embodiment.

FIG. 2 is an explanatory diagram illustrating an example of favorite data illustrated in FIG. 1.

FIG. 3 is a block diagram illustrating a configuration example of a printer driver illustrated in FIG. 1.

FIG. 4 is a flow diagram illustrating an example of a print process of the printer driver illustrated in FIG. 1.

FIG. 5 is an image diagram illustrating an example of a display screen in the print process illustrated in FIG. 4.

FIG. 6 is another image diagram illustrating an example of a display screen in the print process illustrated in FIG. 4.

FIG. 7 is an explanatory diagram illustrating an example of related favorite data illustrated in FIG. 4.

FIG. 8 is another image diagram illustrating an example of a display screen in the print process illustrated in FIG. 4.

FIG. 9A is a flow diagram illustrating an example of a registration process of the printer driver illustrated in FIG. 1.

FIG. 9B is another flow diagram illustrating the example of the registration process of the printer driver illustrated in FIG. 1.

FIG. 10 is an image diagram illustrating an example of a display screen in the registration process illustrated in FIGS. 9A and 9B.

FIG. 11 is another image diagram illustrating an example of a display screen in the registration process illustrated in FIGS. 9A and 9B.

FIG. 12 is another image diagram illustrating an example of a display screen in the registration process illustrated in FIGS. 9A and 9B.

FIG. 13 is an image diagram illustrating an example of a display screen in a print process according to a modified embodiment.

FIG. 14 is a block diagram illustrating a configuration example of an image forming system according to another modified embodiment.

FIG. 15 is an explanatory diagram illustrating an example of an application software related information illustrated in FIG. 14.

FIG. 16 is a flow diagram illustrating an example of a print process of a printer driver illustrated in FIG. 14.

FIG. 17 is another explanatory diagram illustrating an example of related favorite data illustrated in FIG. 16.

FIG. 18A is a flow diagram illustrating an example of a registration process of a printer driver according to another modified embodiment.

FIG. 18B is another flow diagram illustrating the example of the registration process of the printer driver according to the another modified embodiment.

FIG. 19 is an explanatory diagram illustrating an example of a favorite information registered by the process illustrated in FIGS. 18A and 18B.

FIG. 20 is an image diagram illustrating an example of a display screen of a selection process of a printer driver according to another modified embodiment.

FIG. 21 is another image diagram illustrating an example of a display screen of a selection process of the printer driver according to the another modified embodiment.

### DETAILED DESCRIPTION OF THE PREFERRED EMBODIMENT(S)

In the following, an embodiment of the present invention is described with reference to the drawings.

### Embodiment

### Configuration Example

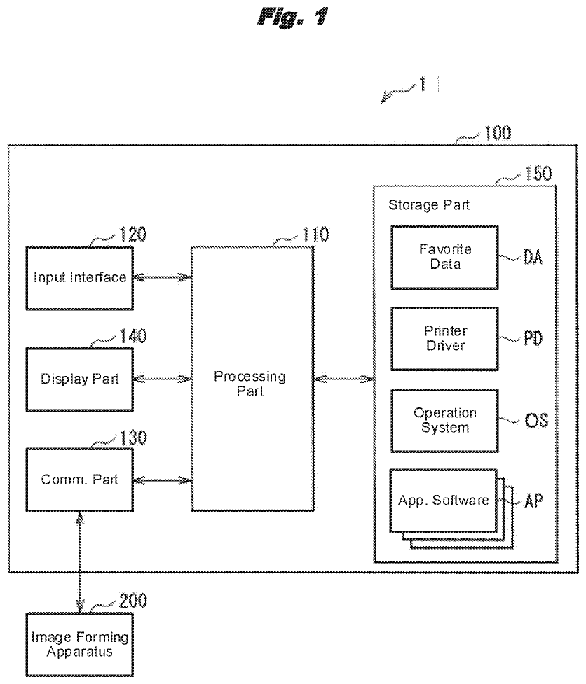

FIG. 1 illustrates a configuration example of an image forming system 1 including an information processing apparatus in which a printer driver according to an embodiment of the present invention is installed. A recording medium is embodied in the present embodiment and this is also described. The image forming system 1 includes an information processing apparatus 100 and an image forming apparatus 200. In the image forming system 1, the information processing apparatus 100 is connected to the image forming apparatus 200. Specifically, the information processing apparatus 100 communicates with the image forming apparatus 200 via, for example, a wired LAN (Local Area Network), a wireless LAN, a USB (Universal Serial Bus), or the like.

The information processing apparatus 100 is, for example, a so-called personal computer. In the information processing apparatus 100, for example, an operating system OS (to be described later), application softwares AP (to be described later), and a printer driver PD (to be described later) are installed. The printer driver PD is configured to generate print data. The print data includes image data indicating an image to be printed and setting values of various print setting items to be used in a print process. Then, the information processing apparatus 100 transmits the generated print data to the image forming apparatus 200.

The image forming apparatus 200 is configured to form a monochrome image or a color image on a print medium such as a sheet of paper by performing an image forming operation using a developer such as a toner based on the print data transmitted from the information processing apparatus 100.

In the image forming system 1, the printer driver PD installed in the information processing apparatus 100 can register setting values customized by a user for various print setting items in favorite data DA as a favorite information D. A favorite information D is registered, for example, in association with a software name and a file extension of an application software AP. Further, the information processing apparatus 100 executes an application software AP (application software AP1) and displays a print setting screen (print setting screen SC1 (to be described later)) based on a print instruction from a user. The information processing apparatus 100 displays a display list LI showing options of multiple registered favorite informations D based on a user operation on the print setting screen SC1. The display list LI is a list of favorite names associated with the favorite informations D. For example, based on the favorite data DA and the application software AP1 that is being executed, the information processing apparatus 100 generates the display list LI so as to display, in an easy-to-select display form, one or more favorite informations D related to the application software AP1 among the multiple registered favorite informations D. The information processing apparatus 100 generates print data based on a favorite information D selected by a user among the multiple favorite informations D included in the display list LI. Then, the information processing apparatus 100 transmits the print data to the image forming apparatus 200, and the image forming apparatus 200 performs an image forming operation based on the print data. As a result, in the image forming system 1, user convenience can be improved.

The information processing apparatus 100 has a processing part 110, an input interface 120, a communication part 130, a display part 140, and a storage part 150.

The processing part 110 is configured to include a processor capable of executing a program, a RAM (Random Access Memory), and the like. Specifically, for example, the processing part 110 executes various programs such as the operating system OS, the application softwares AP, and the printer driver PD.

The input interface 120 is, for example, a mouse or a keyboard, and is configured to receive a user operation.

The communication part 130 is configured to perform communication with the image forming apparatus 200. Specifically, for example, the communication part 130 transmits print data generated by the printer driver PD to the image forming apparatus 200 based on an instruction from the printer driver PD.

The display part 140 is, for example, a liquid crystal display, and is configured to display information showing a processing content of the processing part 110, instruction information to a user, and the like.

The storage part 150 is, for example, a hard disk drive (HDD), a solid state drive (SSD), or the like, and is configured to store various kinds of data such as various programs, various settings, document data, image data, and the like. In this example, the operating system OS, the multiple application softwares AP, and the printer driver PD are installed in the information processing apparatus 100. Further, the storage part 150 stores the favorite data DA.

The operating system OS is configured to perform basic control of the information processing apparatus 100, and is configured to be executed by the processing part 110. The processing part 110 executes the operating system OS, for example, to perform processes that efficiently manage hardware resources, such as memory management and task process management. Further, the operating system OS also has a function of managing a software name of an application software AP installed in the information processing apparatus 100 and a file extension handled by the application software AP by associating the software name and the file extension with each other.

The multiple application softwares AP include, for example, a word processing software, an image editing software, a spreadsheet software, and the like, and are configured to be executed by the processing part 110. The processing part 110 executes, for example, an application software AP to generate, for example, data of a document, an image or the like and stores the data based on a user operation. Further, in a case of executing an application software AP, the processing part 110 performs a process to call the printer driver PD based on a print instruction from a user.

The printer driver PD is a so-called device driver that controls an operation of the image forming apparatus 200, and is configured to be executed by the processing part 110. The printer driver PD is, for example, recorded on a recording medium such as a CD-ROM (Compact Disc-Read Only Memory), and is installed in the information processing apparatus 100 based on a user operation. Or, the printer driver PD is downloaded via the Internet and installed in the information processing apparatus 100 based on a user operation. The printer driver PD generates print data. The printer driver PD registers favorite informations D in the favorite data DA, and can set various print setting items based on one of the favorite informations D included in the favorite data DA.

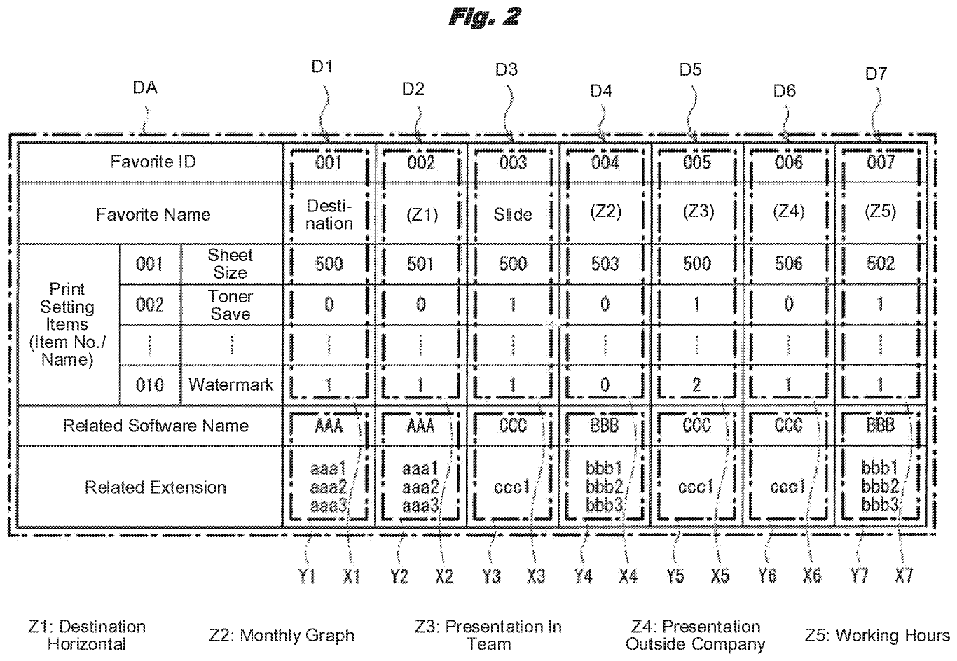

FIG. 2 illustrates an example of the favorite data DA. The favorite data DA is a database including one or more favorite informations D (in this example, seven favorite informations D1-D7). The favorite informations D each include a setting information X and an attribute information Y. Specifically, the favorite information D1 includes a setting information X1 and an attribute information Y1; the favorite information D2 includes a setting information X2 and an attribute information Y2; the favorite information D3 includes a setting information X3 and an attribute information Y3; the favorite information D4 includes a setting information X4 and an attribute information Y4; the favorite information D5 includes a setting information X5 and an attribute information Y5; the favorite information D6 includes a setting information X6 and an attribute information Y6; and the favorite information D7 includes a setting information X7 and an attribute information Y7.

The setting information X includes a favorite ID, a favorite name, and setting values of various print setting items. The favorite ID is information identifying the favorite information D. The favorite name is a name of the favorite information D, and is represented by a combination of letters, numbers, and symbols, and is arbitrarily set by a user. An item number is assigned to each of the multiple print setting items. The multiple print setting items include, for example, a print setting item “Sheet Size” assigned with an item number “001,” a print setting item “Toner Save” assigned with an item number “002,” and a print setting item “Watermark” assigned with an item number “010.” The print setting items include, but are not limited to, “Sheet Size,” “Toner Save,” and “Watermark,” and may include various other items. Here, setting of “Sheet Size” is, for example, setting of a size of a print medium to be used. The “Sheet Size” is set to, for example, “A4,” “B5” or the like. Setting of “Toner Save” is, for example, setting of whether or not to print in a lighter color than usual in order to save toner. Setting of “Watermark” is, for example, setting of whether or not to perform watermark processing on a print target, and when watermark processing is to be applied, what kind of design is to be applied.

In this example, in the setting information X1, “Favorite ID,” “Favorite Name,” “Sheet Size,” “Toner Save” and “Watermark” are respectively set to “001,” “Destination,” “500,” “0,” and “1.” The same applies to the setting informations X2-X7. In this example, the setting values of all the print setting items are integer type numeric data. That is, in the setting of “Sheet Size,” for example, “500” indicates “A4,” “501” indicates “A3,” and “502” indicates “B4.” Similarly, in the setting of “Toner Save,” for example, “0” indicates that toner save is not to be applied, and “1” indicates that toner save is to be applied. Further, in the setting of “Watermark,” for example, “0” indicates that a watermark is not to be applied, “1” indicates that a registered watermark is to be applied, and “2” indicates that another registered watermark is to be applied.

The attribute information Y includes a related software name and a related extension. The related software name is a software name of an application software AP associated with the setting information X. The related extension is a file extension associated with the setting information X. The related extension may include one extension or multiple extensions.

For example, in the attribute information Y1, “Related Software Name” and “Related Extension” are respectively set to “AAA,” and “aaa1, aaa2, aaa3.” Here, “AAA” is a software name of an application software AP associated with the setting information X1. “aaa1, aaa2, aaa3” include three extensions associated with the setting information X1. The same applies to the attribute informations Y2-Y7.

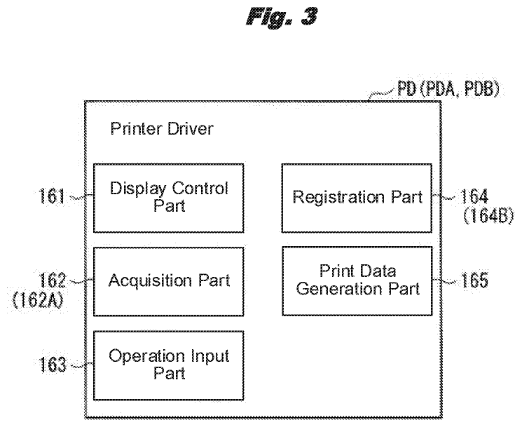

FIG. 3 illustrates a configuration example of the printer driver PD. The printer driver PD has a display control part 161, an acquisition part 162, an operation input part 163, a registration part 164, and a print data generation part 165. The display control part 161 is configured to generate information to be displayed on the display part 140. The acquisition part 162 is configured to acquire information from the application software AP1 that is being executed, and perform processing based on the acquired information. The operation input part 163 is configured to receive an input operation by a user using the input interface 120. The registration part 164 is configured to register, in the favorite data DA, a favorite information D in association with, for example, a software name and a file extension of an application software AP. The print data generation part 165 is configured to generate print data based on setting values of various print setting items.

Here, the favorite data DA corresponds to a specific example of “correspondence information” in the present invention. The setting informations X1-X7 correspond to a specific example of “multiple preset informations” in the present invention. The attribute information Y, the related software name and the related extension correspond to a specific example of a “file attribute information” in the present invention.

### Operation and Effect

Next, operation and effect of the image forming system 1 of the present embodiment is described.

### Overview of Overall Operation

First, with reference to FIGS. 1-3, an overview of an overall operation of the image forming system 1 is described. The information processing apparatus 100 executes an application software AP (application software AP1). For example, when printing is performed, the information processing apparatus 100 displays a print setting screen SC1 based on a print instruction from a user. The information processing apparatus 100 displays a display list LI showing options of multiple registered favorite informations D based on a user operation on the print setting screen SC1. Based on the favorite data DA and the application software AP1 that is being executed, the information processing apparatus 100 generates the display list LI so as to display, in an easy-to-select display form, one or more favorite informations D among the multiple registered favorite informations D. The information processing apparatus 100 generates print data based on the favorite information D selected by a user among the multiple favorite informations D included in the display list LI. Then, the information processing apparatus 100 transmits the print data to the image forming apparatus 200, and the image forming apparatus 200 performs an image forming operation based on the print data.

For example, when a favorite information D is registered in the favorite data DA, the information processing apparatus 100 executes the printer driver PD based on a user operation. The information processing apparatus 100 registers, in the favorite data DA, the favorite information D in association with, for example, a software name and a file extension of an application software AP.

### Detailed Operation

In the following, a print process of the printer driver PD and a registration process of a favorite information D are described in detail.

### Print Process

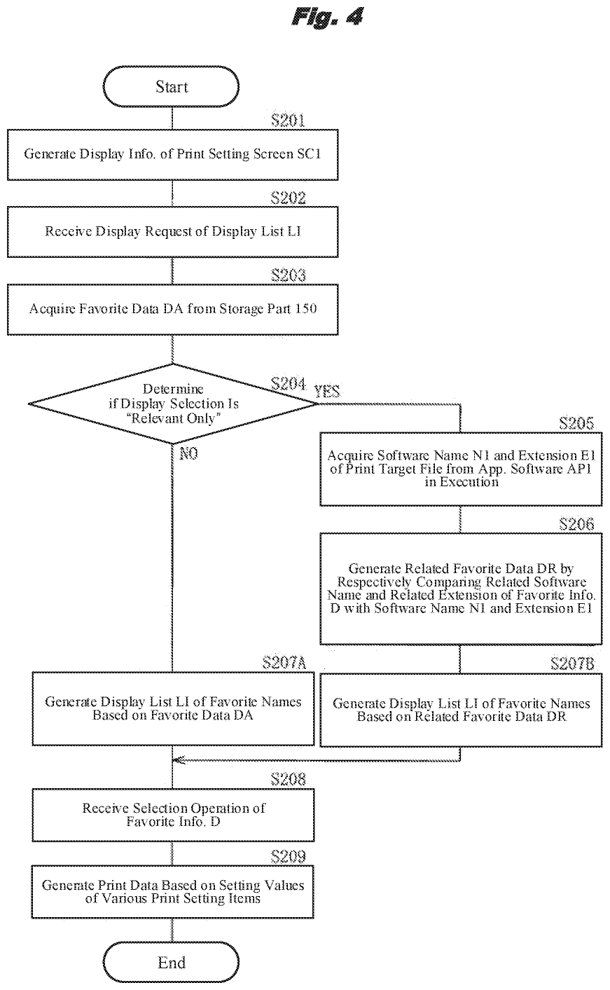

FIG. 4 illustrates an operation example of a print process of the printer driver PD. Among the multiple application softwares AP, an application software AP (application software AP1) that opens a print target file calls the printer driver PD, and thereby, a process starts. In the following, this operation is described in detail.

First, the display control part 161 of the printer driver PD generates display information of the print setting screen SC1 (S201). As a result, the display part 140 displays the print setting screen SC1.

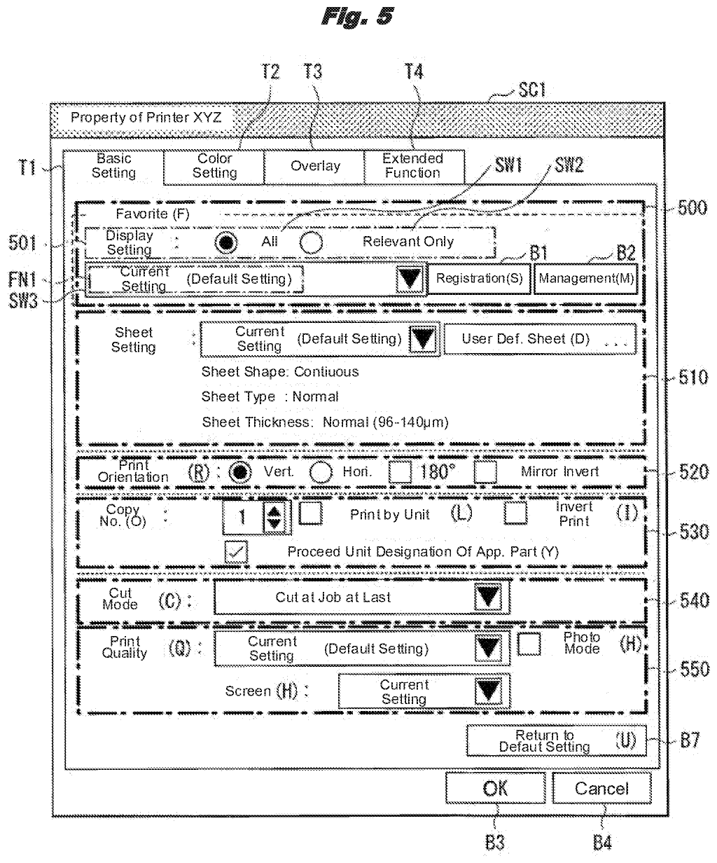

FIG. 5 illustrates an example of the print setting screen SC1. The print setting screen SC1 has a basic setting tab T1, a color setting tab T2, an overlay tab T3, and an extended function tab T4. In this example, the basic setting tab T1 is selected. The print setting screen SC1 further has a favorite field 500, setting fields 510, 520, 530, 540, 550, an OK button B3, a cancel button B4, and a “Return to Default Setting” button B7.

The basic setting tab T1 is, for example, a switch for switching to a screen for performing basic settings such as a sheet size and the number of prints. The color setting tab T2 is, for example, a switch for switching to a screen for setting printing in black and white or printing in color. The overlay tab T3 is, for example, a switch for switching to a screen for setting overlay printing. The extended function tab T4 is, for example, a switch for switching to a screen for setting extended functions such as watermark printing and font change. In this example, four tabs (the basic setting tab T1, the color setting tab T2, the overlay tab T3, and the extended function tab T4) are included. However, the present invention is not limited to this. For example, in addition to these tabs, various other tabs may be included.

The favorite field 500 is a field for registering a favorite information D in the favorite data DA, or selecting a favorite information D to be used from the registered favorite informations D. The favorite field 500 includes a display setting field 501, a pull-down box SW3, a registration button B1, and a management button B2. The display setting field 501 is a field for performing display setting of the display list LI to be displayed in the pull-down box SW3, and includes radio buttons SW1, SW2. The pull-down box SW3 is configured to display the display list LI showing selectable options of the favorite informations D, and receive a selection operation from a user and display a selected favorite name FN1 selected by the user. The radio buttons SW1, SW2 are buttons for setting conditions for generating the display list LI. When the radio button SW1 (“All” radio button SW1) is selected, a display list LI including favorite names of all favorite informations D included in the favorite data DA is generated, and, when the radio button SW2 (“Relevant Only” radio button SW2) is selected, as will be described later, a display list LI including favorite names of favorite informations D satisfying a predetermined condition among all the favorite informations D is generated. The radio button SW1 and the radio button SW2 are mutually exclusive, and setting corresponding to the selected button among the radio button SW1 and the radio button SW2 becomes effective. In an initial state of the print setting screen SC1, the “All” radio button SW1 may be selected, or the “Relevant Only” radio button SW2 may be selected. The registration button B1 is, for example, a button for displaying a registration screen SC2 for registering setting values of various print setting items as a favorite information D in the favorite data DA. The management button B2 is, for example, a button for displaying a management screen for managing the favorite data DA.

The setting field 510 is a field for setting information about a print medium. In this example, in the setting field 510, a user can set a form, type, thickness, and the like of a print medium.

The setting field 520 is a field for setting orientation of a print medium. In this example, in the setting field 520, a user can select to set the orientation of the print medium to portrait, landscape, rotated 180 degrees, or the like by using radio buttons or the like.

The setting field 530 is a field for setting the number of print media to be used and the like. In this example, in the setting field 530, a user can select the number of copies to be printed, a printing order, and the like.

The setting field 540 is a field for setting a condition for cutting a sheet. In this example, in the setting field 540, a user can select a cutting condition by using a pull-down box.

The setting field 550 is a field for setting print quality. In this example, in the setting field 550, a user can select, for example, whether to print in high quality or low quality by using a pull-down box.

In this example, the print setting screen SC1 includes 6 fields (the favorite field 500 and the setting fields 510, 520, 530, 540, 550). However, the present invention is not limited to this. For example, it is also possible to further include various other fields.

The OK button B3 is a button for reflecting the setting values of the various print setting items on the print setting screen SC1 in the print data. The cancel button B4 is a button for terminating the display of the print setting screen SC1 without reflecting the setting values of the various print setting items on the print setting screen SC1 in the print data. The “Return to Default Setting” button B7 is a button for returning the setting values of the various print setting items on the print setting screen SC1 to default setting values.

The display control part 161 generates such a print setting screen SC1.

Next, the operation input part 163 of the printer driver PD receives a display request of the display list LI (S202). Specifically, the operation input part 163 receives a display request of the display list LI based on a user operation with respect to the pull-down box SW3 on the print setting screen SC1.

Next, the display control part 161 acquires the favorite data DA from the storage part 150 (S203).

Next, the display control part 161 determines whether or not the display selection is “Relevant Only” (S204). Specifically, the display control part 161 determines which one of the “All” radio button SW1 and the “Relevant Only” radio button SW2 is selected. When the “All” radio button SW1 is selected (“NO” in S204), the display control part 161 performs a process of S207A. When the “Relevant Only” radio button SW2 is selected (“YES” in S204), the acquisition part 162 performs a process of 5205.

When the “All” radio button SW1 is selected in S204 (“NO” in S204), the display control part 161 generates a display list LI of favorite names based on the favorite data DA (S207A). Specifically, the display control part 161 acquires the favorite names from all the setting informations X (the setting informations X1-X7 in this example) included in the favorite data DA acquired in S203, and generates a display list LI using the acquired information. In the print setting screen In SC1, the pull-down box SW3 displays the generated display list LI.

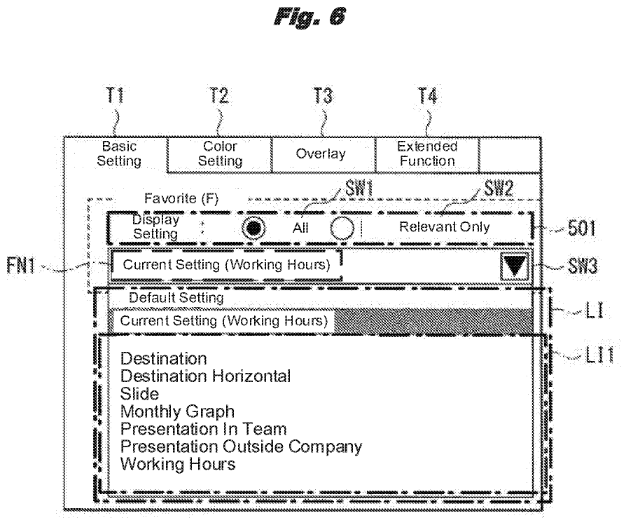

FIG. 6 illustrates an example of the display list LI displayed in the pull-down box SW3 when the “All” radio button SW1 is selected. In this example, the display list LI includes a display list LI1, “Default Setting,” and “Current Setting (Working Hours).” The display list LI1 includes the favorite names of all the setting informations X. In this example, “Destination,” “Destination Horizontal,” “Slide,” “Monthly Graph,” “Presentation: In Team,” “Presentation: Outside the Company,” and “Working Hours” respectively corresponds to the favorite names of the setting informations X1-X7. “Default Setting” is, for example, initial setting or the like. In the “Default Setting,” the setting values of the various print setting items are set to predetermined setting values. The “Current Setting” is the setting displayed on the print setting screen SC1 before the selection operation of the pull-down box SW3. It is not always necessary to display the “Default Setting” and the “Current Setting.” As a result, the process in the case where the “All” radio button SW1 is selected is terminated.

When the “Relevant Only” radio button SW2 is selected in S204 (“YES” in S204), the acquisition part 162 of the printer driver PD acquires a software name N1 and an extension E1 of a print target file from the application software AP1 that is being executed (S205). Specifically, for example, the acquisition part 162 acquires the software name N1 and the extension E1 by inquiring the application software AP1 that has opened the print target file about the software name N1 and the extension E1 used by the application software AP1. When meta information of the print target file includes the software name N1 and the extension E1, the software name N1 and the extension E1 may be acquired from the print target file. In this example, an operation when the software name N1 and the extension E1 of the application software AP1 are respectively “CCC” and “ccc1, ccc2, ccc3” is described. Here, the software name N1 and the extension E1 correspond to a specific example of a “first file attribute information” in the present invention.

Next, the acquisition part 162 generates related favorite data DR by respectively comparing the related software name and the related extension of each of the multiple favorite informations D included in the favorite data DA with the software name N1 and the extension E1 (S206). Specifically, first, the acquisition part 162 acquires the related software names and the related extensions of all the favorite informations D (the favorite informations D1-D7 in this example) included in the favorite data DA acquired in S203. As illustrated in FIG. 2, the related software names of the favorite informations D1-D7 are “AAA,” “AAA,” “CCC,” “BBB,” “CCC,” “CCC,” and “BBB.” Similarly, the related extensions of the favorite informations D1-D7 are “aaa1, aaa2, aaa3,” “aaa1, aaa2, aaa3,” “ccc1,” “bbb1, bbb2, bbb3,” “ccc1,” “ccc1,” and “bbb1, bbb2, bbb3.”

The acquisition part 162 compares the related software name of each of the favorite informations D1-D7 with the software name N1 (“CCC” in this example) acquired in S205, and selects each favorite information D of which the related software name matches the software name N1. In this example, the favorite informations D3, D5, D6 are selected. Similarly, the acquisition part 162 compares the related extension of each of the favorite informations D1-D7 with the extension E1 (“ccc1” in this example) acquired in S205, and selects each favorite information D of which the related extension matches the extension E1. In this example, the favorite informations D3, D5, D6 are selected. The acquisition part 162 generates the related favorite data DR based on all the favorite informations D selected in this way. In this example, the acquisition part 162 generates the related favorite data DR based on the favorite informations D3, D5, D6.

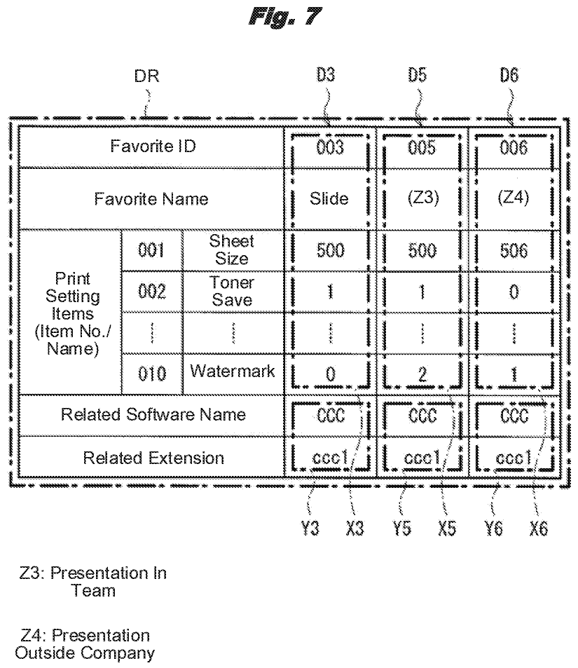

FIG. 7 illustrates an example of the related favorite data DR generated in S206. In this example, the related favorite data DR includes the favorite informations D3, D5, D6. Here, the related software names of the favorite informations D3, D5, and D6 are all “CCC.” Similarly, the related extensions of the favorite informations D3, D5, and D6 are all “ccc1.”

Next, the display control part 161 generates a display list LI of favorite names based on the related favorite data DR (S207B). Specifically, the display control part 161 acquires the favorite names of the favorite informations D3, D5, D6 from the related favorite data DR generated in S206, and generates the display list LI using the acquired information. On the print setting screen SC1, the pull-down box SW3 displays the display list LI.

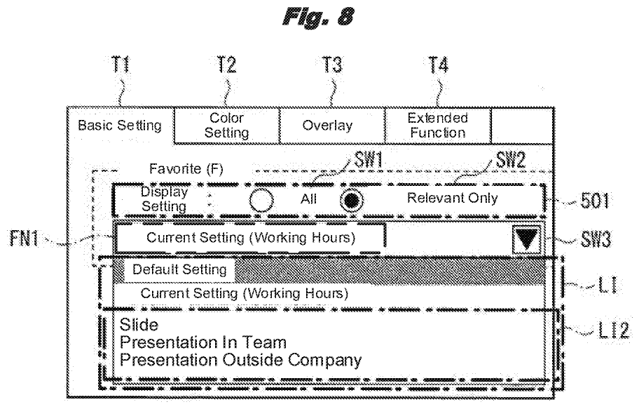

FIG. 8 illustrates an example of the display list LI displayed in the pull-down box SW3 when the “Relevant Only” radio button SW2 is selected. The display list LI includes a display list LI2, “Default Setting,” and “Current Setting (Presentation: In Team).” The display list LI2 includes all the favorite names of the setting informations X included in the related favorite data DR. In this example, in the display list LI2, “Slide,” “Presentation: In Team,” and “Presentation: Outside the Company” respectively correspond to the favorite names of the setting informations X3, X5, X6. That is, the display list LI2 does not include the favorite names of the setting informations X1, X2, X4, X7. As a result, the process in the case where the “Relevant Only” radio button SW2 is selected is terminated.

Next, the operation input part 163 receives a selection operation of a favorite information D (S208). Specifically, the operation input part 163 receives a selection operation of a favorite information D based on a user operation with respect to the display list LI displayed in the pull-down box SW3. The display control part 161 acquires the setting information X including the favorite name (selected favorite name FN1) of the favorite information D selected by the user among the setting informations X included in the multiple favorite informations D. Then, the display control part 161 updates the setting values of the various print setting items on the print setting screen SC1 based on the acquired setting information X. The display control part 161 can receive a change operation of a setting value in any setting field even after receiving a selection operation of a favorite information D.

Next, the print data generation part 165 of the printer driver PD generates print data based on the setting values of the various print setting items set on the print setting screen SC1 (S209). Specifically, the operation input part 163 receives a user operation with respect to the OK button B3 on the print setting screen SC1. Then, the print data generation part 165 generates print data of the print target file based on the setting values of the various print setting items. The communication part 130 transmits the print data to the image forming apparatus 200. The image forming apparatus 200 forms an image based on the print data.

As a result, this flow is terminated.

### Registration Process

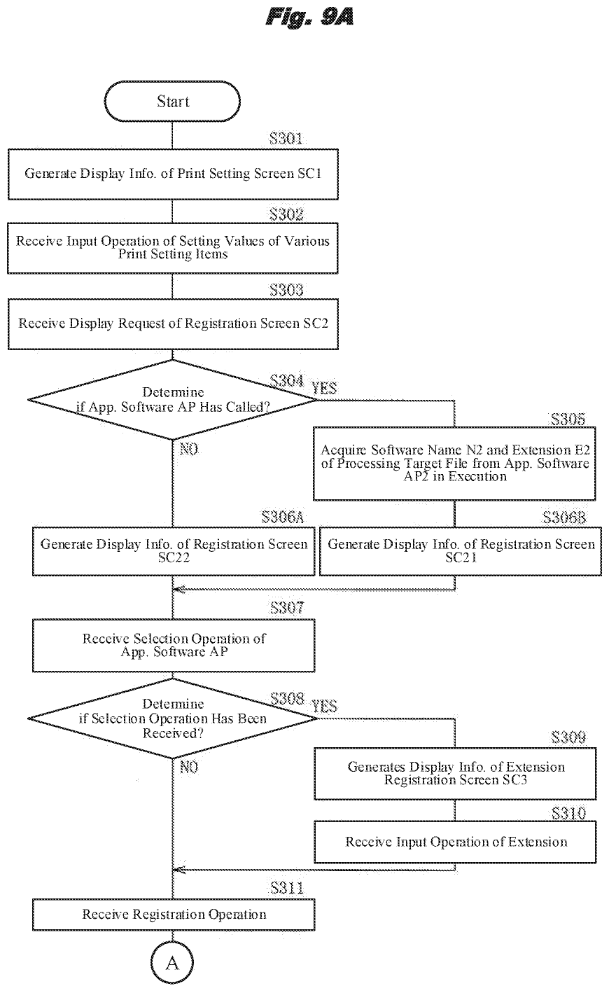

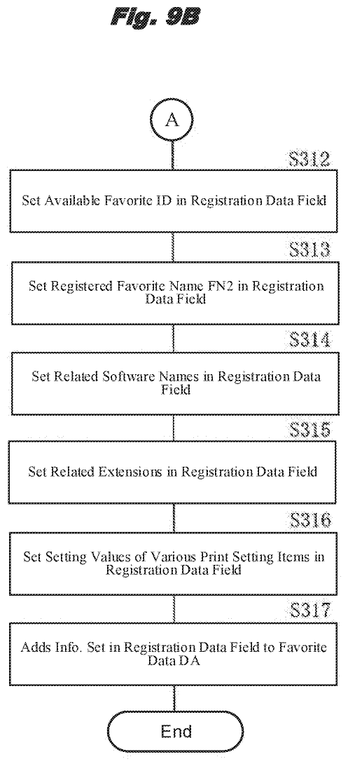

FIGS. 9A and 9B illustrate an operation example of a registration process of a favorite information D in the printer driver PD. The operating system OS or an application software AP calls the printer driver PD, and thereby, a process starts. In the following, this operation is described in detail.

First, the display control part 161 of the printer driver PD generates display information of the print setting screen SC1 (S301). A specific process is the same as the process of 5201 in the print process illustrated in FIG. 4. As a result, the display part 140 displays the print setting screen SC1.

Next, the operation input part 163 of the printer driver PD receives an input operation of setting values of the various print setting items on the print setting screen SC1 (S302).

Next, the operation input part 163 receives a display request of the registration screen SC2 (S303). Specifically, the operation input part 163 receives the display request of the registration screen SC2 based on a user operation with respect to the registration button B1 of the print setting screen SC1.

Next, the display control part 161 determines whether or not the application software AP has called the printer driver PD (S304). Specifically, the display control part 161 inquires, for example, an application software AP or the operating system OS about whether or not the print setting screen SC1 has been called. When one application software AP (application software AP2) among the multiple application softwares AP has called the print setting screen SC1 (“YES” in S304), the registration part 164 of the printer driver PD performs a process of S305. When the operating system OS has called the print setting screen SC1 (“NO” in S304), the display control part 161 performs a process of S306A.

In S304, when the application software AP2 has called the print setting screen SC1 (“YES” in S304), the registration part 164 acquires a software name N2 and an extension E2 of a processing target file from the application software AP2 that is being executed (S305). Specifically, for example, the registration part 164 acquires the software name N2 and the extension E2 by querying the application software AP2 about the software name N2 of the application software AP2 and the extension E2 used by the application software AP2. When meta information of the processing target file processed by the application software AP2 includes the software name N2 and the extension E2, the software name N2 and the extension E2 may be acquired from the processing target file. In this example, an operation when the software name N2 and the extension E2 of the application software AP2 are respectively “DDD” and “ddd1” is described. Here, the software name N2 and the extension E2 correspond to a specific example of a “second file attribute information” in the present invention.

Next, the display control part 161 generates display information of the registration screen SC2 (registration screen SC21) (S306B). Specifically, the display control part 161 uses information of multiple application softwares AP managed by the operating system OS to generate a list of software names of multiple application softwares AP excluding the application software AP2, and, based on this list, generates display information of the registration screen SC21. Then, the display part 140 displays the registration screen SC21.

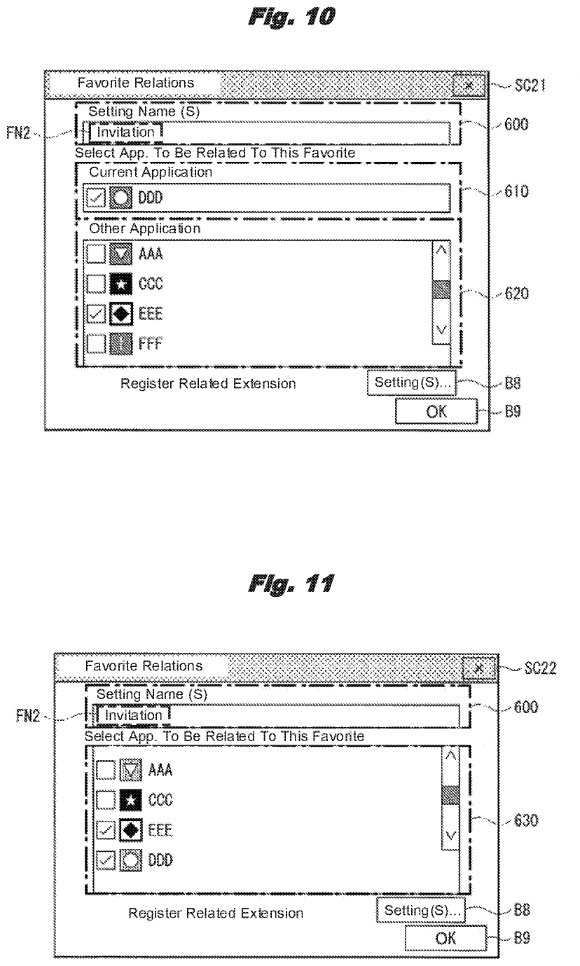

FIG. 10 illustrates an example of the registration screen SC21. The registration screen SC21 includes a “Setting Name” field 600, a “Current Application” field 610, an “Other Applications” field 620, a setting button B8, and an OK button B9.

The “Setting Name” field 600 is a field for inputting in a text box a favorite name of a favorite information D to be registered (registered favorite name FN2). In this example, “Invitation” is the registered favorite name FN2.

The “Current Application” field 610 is a field for displaying the software name N2 of the application software AP2 that is being executed, and for selecting, based on a user operation, whether or not to associate the favorite information D to be registered with the application software AP2 that is being executed. In this example, “DDD” is the software name N2 acquired in S305. In this example, a check box is not checked. In an initial state of the registration screen SC21, the check box is automatically checked. As a result, the favorite information D to be registered is associated with the application software AP2 of which the software name is “DDD.” At the same time, the favorite information D to be registered is associated with the extension “ddd1” of the application software AP of which the software name is “DDD.”

The “Other Applications” field 620 is a field for displaying the software names of the multiple application softwares AP managed by the operating system OS, and for selecting, based on a user operation, whether or not to associate the favorite information D to be registered with these application softwares AP. In this example, “AAA,” “CCC,” “EEE,” and “FFF” are all software names of application softwares AP. In the initial state of the registration screen SC21, all check boxes in the “Other Applications” field 620 are not checked.

The setting button B8 is a button for displaying an extension registration screen SC3. The OK button B9 is a button for confirming settings performed by a user on the registration screen SC2.

As a result, the process in the case where the application software AP2 has called the printer driver PD is terminated.

In S304, when the operating system OS has called the print setting screen SC1 (“NO” in S304), the display control part 161 generates display information of the registration screen SC2 (registration screen SC22) (S306A). Specifically, the display control part 161 uses the information of the multiple application softwares AP managed by the operating system OS to generate a list of the software names of the multiple application softwares AP, and, based on this list, generates display information of the registration screen SC22. The display part 140 displays the registration screen SC22.

FIG. 11 illustrates an example of the registration screen SC22. The registration screen SC22 includes a “Setting Name” field 600, a “Related Applications” field 630, a setting button B8, and an OK button B9.

The “Related Applications” field 630 is a field for displaying the software names of the multiple application softwares AP managed by the operating system OS, and for selecting, based on a user operation, whether or not to associate the favorite information D to be registered with these application softwares AP. In this example, “AAA,” “CCC,” “EEE,” and “DDD” are each a software name. Here, in an initial state of the registration screen SC22, all check boxes in the “Other Applications” field 620 are not checked.

As a result, the process in the case where the operating system OS has called the printer driver PD is terminated.

Next, the operation input part 163 receives a selection operation of the application software AP by a user on the registration screen SC2 (registration screen SC21 or SC22) (S307). Specifically, when the registration screen SC21 is displayed, the operation input part 163 receives a user operation with respect to the “Other Applications” field 620 on the registration screen SC21, and receives a display request of the display list LI. Here, the software name of the application software AP, which is a software name for which a check box in the “Other Applications” field 620 is checked, and the extension thereof correspond to a specific example of a “second file attribute information” in the present invention. Further, when the registration screen SC22 is displayed, the operation input part 163 receives a user operation with respect to the “Related Applications” field 630 on the registration screen SC22, and receives a display request of the display list LI. Here, the software name of the application software AP, which is a software name for which a check box in the “Related Applications” field 630 is checked, and the extension thereof correspond to a specific example of a “second file attribute information” in the present invention.

In the example of FIG. 10, a check box corresponding to an application software AP of which the software name is “EEE” is checked by a user operation with respect to the “Other Applications” field 620, and this application software AP is selected. As a result, the favorite information D to be registered is associated with the application software AP of which the software name is “EEE.” Further, the display control part 161 acquires an extension “eee1” of the application software AP of which the software name is “EEE” using the information managed by the operating system OS. As a result, the favorite information D to be registered is associated with the extension “eee1” of the application software AP of which the software name is “EEE.”

Further, in the example of FIG. 11, by a user operation with respect to the “Related Applications” field 630, a check box corresponding to an application software AP of which the software name is “EEE,” and a check box corresponding to an application software AP of which the software name is “DDD” are checked, and these application softwares AP are selected. As a result, the favorite information D to be registered is associated with the application software AP of which the software name is “EEE” and the application software AP of which the software name is “DDD.” Further, the display control part 161 uses the information managed by the operating system OS to acquire the extension “eee1” of the application software AP of which the software name is “EEE” and the extension “ddd1” of the application software AP of which the software name is “DDD.” As a result, the favorite information D to be registered is associated with the extension “eee1” of the application software AP of which the software name is “EEE” and the extension “ddd1” of the application software AP of which the software name is “DDD.”

Next, the operation input part 163 determines whether or not a selection operation of the setting button B8 has been received (S308). When a selection operation of the setting button B8 is received (“YES” in S308), the display control part 161 performs a process of S309. When a selection operation of the setting button B8 is not received (“NO” in S308), the display control part 161 performs a process of S311.

In S308, when a selection operation of the setting button B8 is received (“YES” in S308), the display control part 161 generates display information of the extension registration screen SC3 (S309). Specifically, the display control part 161 generates the display information of the extension registration screen SC3 based on the extension that is acquired in S307 and is associated with the favorite information D to be registered. The display part 140 displays the extension registration screen SC3.

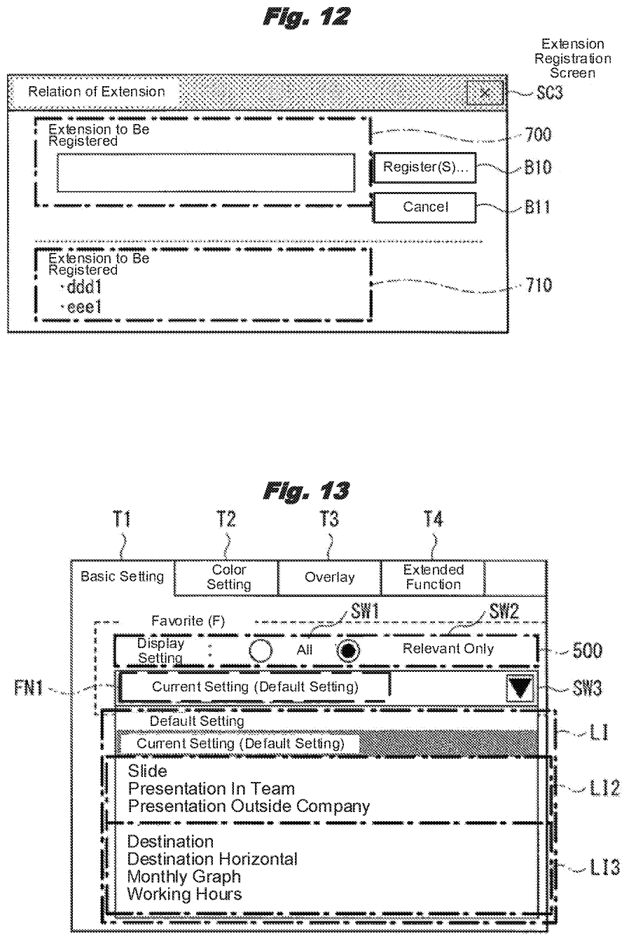

FIG. 12 illustrates an example of the extension registration screen SC3. The extension registration screen SC3 includes an “Extension Input” field 700, an “Extension” field 710, a registration button B10, and a cancel button B11.

The “Extension Input” field 700 is a field for inputting in a text box an extension to be registered.

The “Extension” field 710 is a field for displaying the extension that is acquired in S307 and is associated with the favorite information D to be registered. In this example, “ddd1” is the extension of the application software AP of which the software name is “DDD” and “eee1” is the extension of the application software AP of which the software name is “EEE.”

The registration button B10 is a button for associating the favorite information D to be registered with the extension input in the text box of the “Extension Input” field 700. The cancel button B11 is a button for performing a process to cancel the extension information input in the text box of the “Extension Input” field 700 and return to the previous screen.

Next, the operation input part 163 receives an input operation of an extension (S310). Specifically, the operation input part 163 receives an extension input in the text box of the “Extension Input” field 700 based on a user operation with respect to the registration button B10 on the extension registration screen SC3. As a result, the favorite information D to be registered is associated with the extension input in the text box of the “Extension Input” field 700 in addition to the extension acquired in S307. As a result, the operation input part 163 terminates the display of the extension registration screen SC3. As a result, the process in the case where the selection of the setting button B8 is received is terminated.

Next, the operation input part 163 receives a registration operation by a user (S311). Specifically, the operation input part 163 performs a registration request with respect to the registration part 164 based on a user operation with respect to the OK button B9 on the registration screen SC2 (registration screen SC21 or SC22).

Next, the registration part 164 of the printer driver PD sets an available favorite ID in a registration data field (S312). Specifically, the registration part 164 prepares a registration data field for storing the favorite information D to be registered. The registration data field is a storage area temporarily secured in a memory or the like in the processing part 110. The registration part 164 acquires, for example, a favorite ID (for example, “010”) that is not a duplicate of any favorite ID that is already in use in the favorite data DA (FIG. 2). The registration part 164 sets the acquired favorite ID (for example, “010”) in the registration data field.

Next, the registration part 164 sets the registered favorite name FN2 in the registration data field (S313). Specifically, the registration part 164 sets, in the registration data field, the registered favorite name FN2 (“Invitation” in this example) input in the “Setting Name” field 600 of the registration screen SC2 (registration screen SC21 or SC22).

Next, the registration part 164 sets the related software names in the registration data field (S314). Specifically, the registration part 164 sets in the registration data field the software names (“DDD” and “EEE” in this example) of the application softwares AP that are associated, in S307, with the favorite information D to be registered.

Next, the registration part 164 sets the related extensions in the registration data field (S315). Specifically, the registration part 164 sets in the registration data field the extensions (“ddd1” and “eee1” in this example) that are associated, in S307 and S310, with the favorite information D to be registered.

Next, the registration part 164 sets the setting values of the various print setting items in the registration data field (S316). Specifically, the registration part 164 sets in the registration data field the setting values of the various print setting items input in S302.

Next, the registration part 164 adds the information set in the registration data field to the favorite data DA (S317). Specifically, the registration part 164 registers the favorite ID, the registered favorite name FN2, the setting values of the various print setting items, the related software names and the related extensions, which are set in registration data field, as a favorite information D in the favorite data DA.

As a result, this flow is terminated.

In this way, in the image forming system 1, in a print process, based on the favorite data DA and the software name N1 and extension E1 of the application software AP1 that is being executed, the printer driver PD uses the display list LI to display, in an easy-to-select display form, one or more favorite informations D among the multiple favorite informations D included in the favorite data DA. That is, one or more favorite informations D are preferentially displayed. Specifically, the printer driver PD displays the favorite informations D associated with the software name N1 and the extension E1 of the application software AP1 that is being executed among the multiple favorite informations D included in the favorite data DA. As a result, in the image forming system 1, high-priority options can be presented, and a user can perform a selection of a favorite name in a short time and easily, and thus, user convenience can be improved.

That is, when all the multiple favorite informations D included in the favorite data DA are displayed, a user needs to select a desired favorite name from many favorite names included in a display list, and thus, it takes time and effort. Further, when the number of the favorite names included in the display list is large, it may not be possible to display all the favorite names at once, and in that case, for example, a user operation such as scrolling the display list is required, and thus, it takes user's time and effort. On the other hand, in the image forming system 1, one or more favorite informations D among the multiple favorite informations D included in the favorite data DA are preferentially displayed. Therefore, selection of a favorite name can be performed in a short time and easily, and thus, user convenience can be improved.

Further, in the image forming system 1, in a print process, based on a user operation, the printer driver PD generates a display list LI based on all the multiple favorite informations D included in the favorite data DA, or generates a display list LI based on one or more favorite informations D among the multiple favorite informations D. As a result, when the favorite data DA does not include a favorite information D associated with the application software AP1 that is being executed, and a high-priority option cannot be presented, a display list LI can be generated based on all the multiple favorite informations D. Therefore, for example, even when an application software AP is used for the first time, a print process can be performed by selecting a favorite information D already associated with another application software AP. In this way, a user can freely select a favorite information D to be used, and thus, user convenience can be improved.

Further, in the image forming system 1, in a registration process of a favorite information D, in the case of being called from an application software AP2, the printer driver PD registers the favorite information D by associating the setting values of the various print setting items set in the registration screen SC2 with the software name N2 and extension E2 of the application software AP2. As a result, a user can easily associate the setting values of the various print setting items with the application software AP2, and thus, user convenience can be improved.

### Effects

As described above, in the present embodiment, in a print process, based on the favorite data and the software name and extension of the application software that is being executed, one or more favorite informations included in the favorite data are preferentially displayed using a display list. Therefore, a user can select a favorite name in a short time and easily, and thus, user convenience can be improved.

In the present embodiment, in a print process, based on a user operation, a display list is generated based on all the favorite informations included in the favorite data, or a display list is generated based on one or more favorite informations among the multiple favorite information. Therefore, a user can more freely select a favorite information to use, and thus, user convenience can be improved.

In the present embodiment, in a registration process of a favorite information, in the case of calling from an application software, the favorite information is registered by associating the setting values of the various print setting items set in the registration screen with the software name and extension of the application software, and thus, user convenience can be improved.

### First Modified Embodiment

In the above embodiment, in S207B of the print process illustrated in FIG. 4, the display control part 161 generates the display list LI2 based on the related favorite data DR and displays the display list LI2. However, the present invention is not limited to this. Instead of this, for example, it is also possible that the display control part 161 generates the display list LI2 based on the related favorite data DR, and further generates a display list LI3 of favorite names based on favorite informations D other than the favorite informations D included in the related favorite data DR among the multiple favorite informations D included in the favorite data DA, and sequentially arranges and displays the display list LI2 and the display list LI3 in order of priority. In the following, the present modified embodiment is described in detail.

FIG. 13 illustrates an example of the display list LI according to the present modified embodiment. In this example, the “Relevant Only” radio button SW2 is selected. The display list LI includes the display list LI2, the display list LI3, “Default Setting,” and “Current Setting (Working Hours).” The display list LI2 includes all the favorite names of the setting informations X included in the related favorite data DR. Specifically, “Slide,” “Presentation: In Team,” and “Presentation: Outside the Company” respectively correspond to setting informations X3, X5, and X6. Further, the display list LI3 includes favorite names of setting informations X that are not included in the related favorite data DR. Specifically, “Destination,” “Destination Horizontal,” “Monthly Graph,” and “Working Hours” respectively correspond to setting informations X1, X2, X4, and X7. The display list LI2 is a high priority list associated with the application software AP1 that is being executed, and thus, is displayed preferentially above the display list LI3.

### Second Modified Embodiment

In the above embodiment, in S207B of the print process illustrated in FIG. 4, the display control part 161 generates the display list LI2 based on the related favorite data DR and displays the display list LI2. However, the present invention is not limited to this. Instead of this, for example, it is also possible that the display control part 161 generates the display list LI of all the favorite informations D included in the favorite data DA, highlights the favorite informations D included in the related favorite data DR in the display list LI, and displays the display list LI. Specifically, for example, it is also possible that the display control part 161 changes the font and color of the items indicating the favorite informations D included in the related favorite data DR in the display list LI, and displays the display list LI.

### Third Modified Embodiment

In the above embodiment, in the print process, the display list LI is generated based on the software name N1 and the print target file extension E1 of the application software AP1 that is being executed. However, the present invention is not limited to this. Instead of this, for example, it is also possible that the display list LI is generated based on another application software AP related to the application software AP that is being executed. In the following, an image forming system 2 according to the present modified embodiment is described in detail.

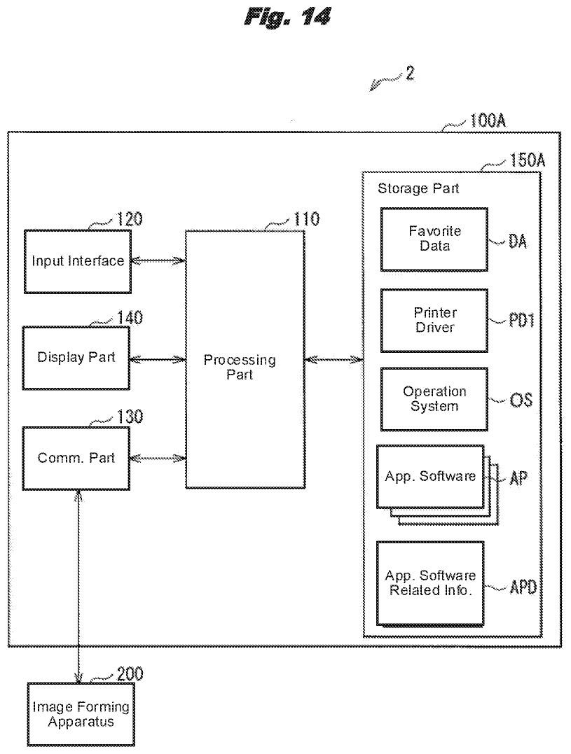

FIG. 14 illustrates a configuration example of the image forming system 2. The image forming system 2 includes an information processing apparatus 100A and the image forming apparatus 200. The information processing apparatus 100A has a processing part 110, an input interface 120, a communication part 130, a display part 140, and a storage part 150A. In the information processing apparatus 100A, an operating system OS, application softwares AP and a printer driver PDA are installed. Further, the storage part 150A stores favorite data DA and application software related information APD.

As illustrated in FIG. 3, the printer driver PDA has a display control part 161, an acquisition part 162A, an operation input part 163, a registration part 164, and a print data generation part 165. The acquisition part 162A is configured to acquire information from an application software AP (application software AP3) that is being executed, acquire information from the application software related information APD, and perform processing based on the acquired information.

The application software related information APD is information indicating a correspondence relationship between the multiple application softwares AP. The application software related information APD is generated by the operating system OS based on information of the application softwares AP managed by the operating system OS. It is also possible that the application software related information APD is generated, for example, by the printer driver PD based on the information of the application softwares AP managed by the operating system OS. Further, for example, it is also possible that the application software related information APD is distributed together with the printer driver PD and is stored in the storage part 150A when the printer driver PD is installed.

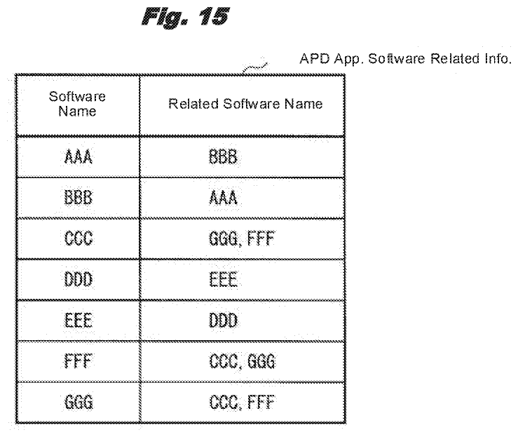

FIG. 15 illustrates an example of the application software related information APD. In the application software related information APD, a software name of an application software AP is associated with a software name of another application software AP related to the application software AP. Specifically, for example, an application software AP (application software AP3) of which the software name is “AAA” is associated with an application software AP (application software AP4) of which the software name is “BBB.” Specifically, for example, the application software AP3 is a word processing software, and the application software AP4 is a spreadsheet software. That is, the two application softwares AP3 and AP4 are both so-called office softwares that users use, for example, for company business. Therefore, in this example, the two application softwares AP3 and AP4 are associated with each other. In this example, an operation when the software name N3 and the extension E3 of the application software AP3 are respectively “AAA” and “aaa1, aaa2, aaa3” and the software name N4 and the extension E4 of the application software AP4 are respectively “BBB” and “bbb1, bbb2, bbb3” is described. Here, the software name N3 and the extension E3 correspond to a specific example of a “first file attribute information” in the present invention.

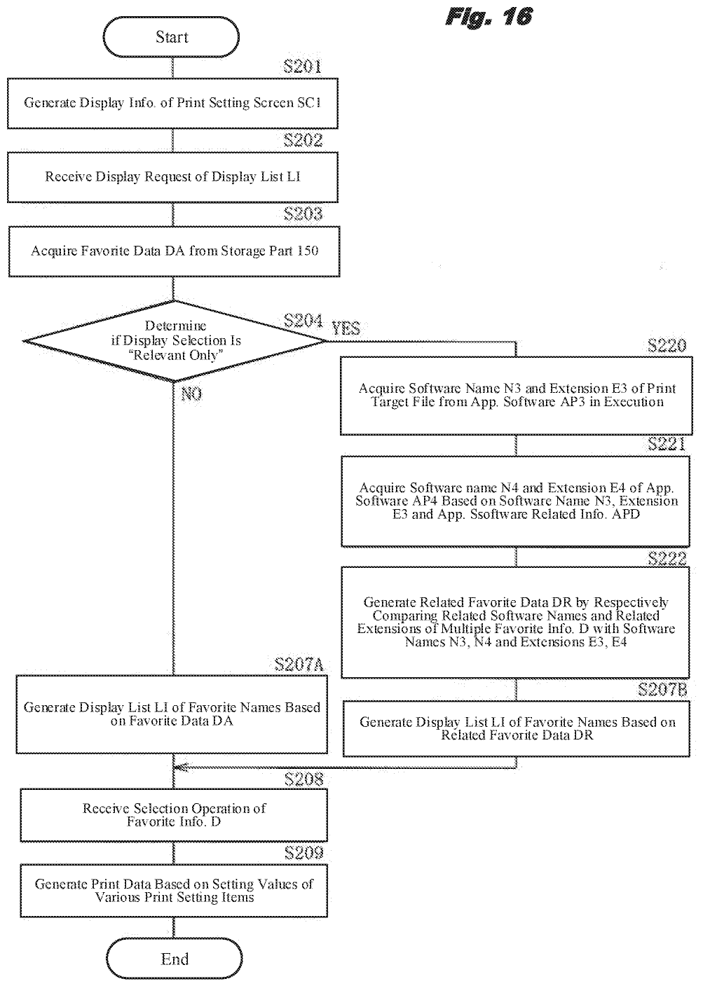

FIG. 16 illustrates an operation example of a print process of the printer driver PDA. Among the multiple application softwares AP, an application software AP (application software AP3) that executes a print target file calls the printer driver PDA, and thereby, a process starts. Processes of S201 to S204 are the same as those of the printer driver PD according to the above embodiment.

When the “Relevant Only” radio button SW2 is selected in S204 (“Y” in S204), the acquisition part 162A of the printer driver PDA acquires a software name N3 and an extension E3 of a print target file from the application software AP3 that is being executed (S220).

Next, the acquisition part 162A acquires the software name N4 and the extension E4 of the application software AP4 based on the software name N3, the extension E3, and the application software related information APD (S221). Specifically, first, the acquisition part 162A acquires the software name N4 of the application software AP (application software AP4) related to the application software AP3 from the application software related information APD of the storage part 150A. Then, the acquisition part 162A acquires the extension E4 of the application software AP4 using the information managed by the operating system OS.

In this example, as illustrated in FIG. 15, “AAA” which is the software name N3 of the application software AP3 is associated with “BBB” which is the software name N4 of the related application software AP4. Therefore, the acquisition part 162A acquires “BBB” which is the software name N4 of the application software AP4. Then, the acquisition part 162A uses the information managed by the operating system OS to acquire “bbb1, bbb2, bbb3” which is the extension E4 of the application software AP4.

Next, by respectively comparing the software names and the extensions of the multiple favorite informations D included in the favorite data DA with the software names N3, N4 and the extensions E3, E4 acquired in S220 and S221, the acquisition part 162A generates the related favorite data DR (S222). In this example, the acquisition part 162A compares the related software names (FIG. 2) of the favorite informations D1-D7 with the software names “AAA” and “BBB” acquired in S220 and S221. The acquisition part 162A selects each favorite information D of which the related software name matches “AAA” or “BBB.” That is, in this example, the favorite informations D1, D2, D4, and D7 are selected. Similarly, the acquisition part 162A compares the related extensions (FIG. 2) of the favorite informations D1-D7 with the extensions “aaa1, aaa2, aaa3” and “bbb1, bbb2, bbb3” which are the extensions acquired in S220 and S221. The acquisition part 162A selects each favorite information D of which the related extension matches “aaa1, aaa2, aaa3” or “bbb1, bbb2, bbb3.” That is, in this example, the favorite informations D1, D2, D4, and D7 are selected.

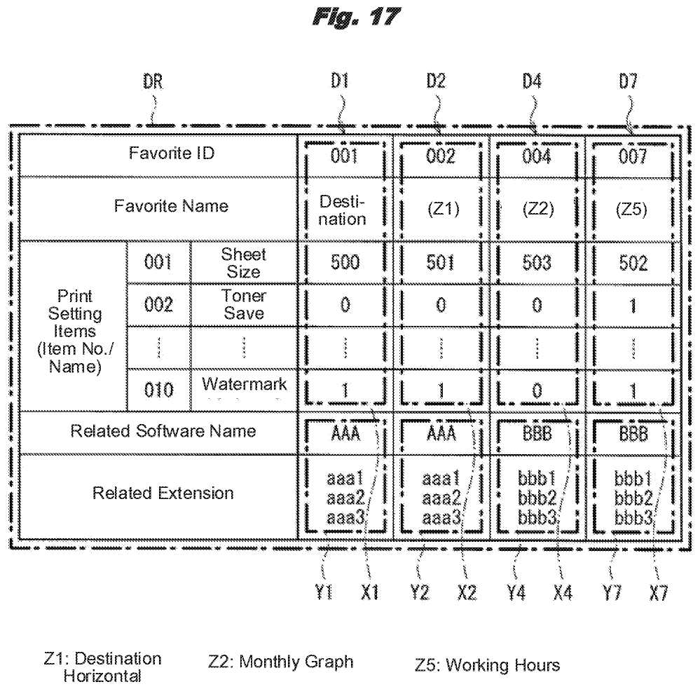

FIG. 17 illustrates an example of the related favorite data DR generated in S222. In this example, the related favorite data DR includes the favorite informations D1, D2, D4, and D7. Here, the related software names of the favorite informations D1, D2, D4, and D7 are all “AAA” or “BBB.” Similarly, the related extensions of the favorite informations D1, D2, D4, and D7 are all “aaa1, aaa2, aaa3” or “bbb1, bbb2, bbb3.”

Next, the display control part 161 of the printer driver PDA generates a display list LI of favorite names based on the related favorite data DR (S207B). Subsequent processes are the same as those in the case of the above embodiment (FIG. 4).

In this way, in the image forming system 2, the display list LI is generated based on also the other application softwares AP4 related to the application software AP3 that is being executed. Therefore, for example, when a print process is performed, the number of options of favorite informations D that are likely to be used by a user can be increased, and thus, user convenience can be improved.

### Fourth Modified Embodiment

In the above embodiment, in a registration process of a favorite information D, for example, the favorite information D is registered by associating the favorite information D with the software name N2 and the processing target file extension E2 of the application software AP2 that is being executed. However, the present invention is not limited to this. Instead of this, for example, it is also possible that the favorite information D is registered by associating the favorite information D with the application software AP that is being executed and another application software AP related to the application software AP. In the following, an image forming system 3 according to the present modified embodiment is described in detail.

As illustrated in FIG. 14, the image forming system 3 includes an information processing apparatus 100B and the image forming apparatus 200. The information processing apparatus 100B has a processing part 110, an input interface 120, a communication part 130, a display part 140, and a storage part 150B. In the information processing apparatus 100B, an operating system OS, application softwares AP and a printer driver PDB are installed. Further, the storage part 150B stores favorite data DA and application software related information APD.

As illustrated in FIG. 3, the printer driver PDB has a display control part 161, an acquisition part 162, an operation input part 163, a registration part 164B, and a print data generation part 165. The registration part 164B is configured to register a favorite information D in the favorite data DA using the application software related information APD.

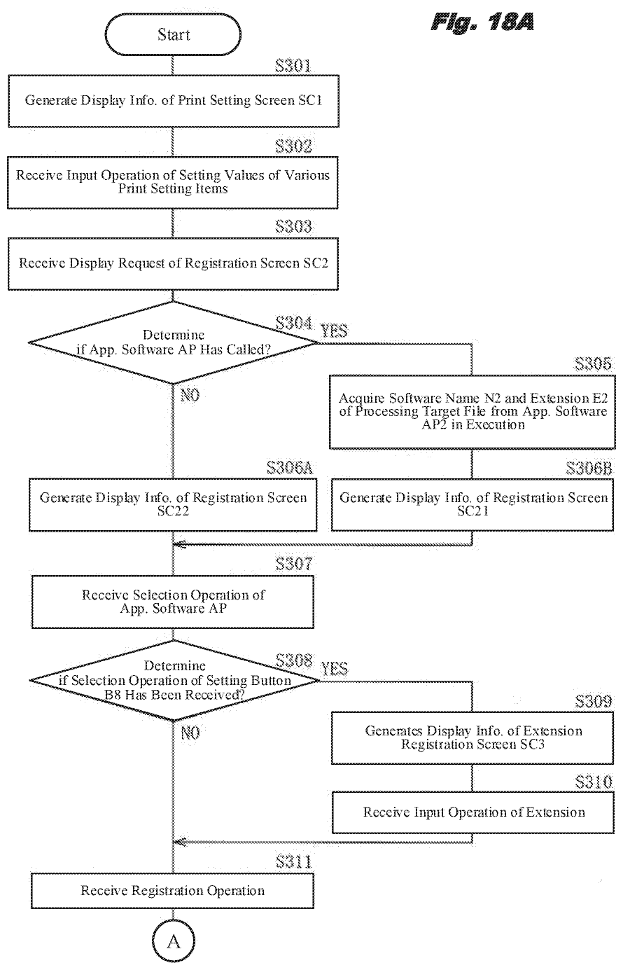

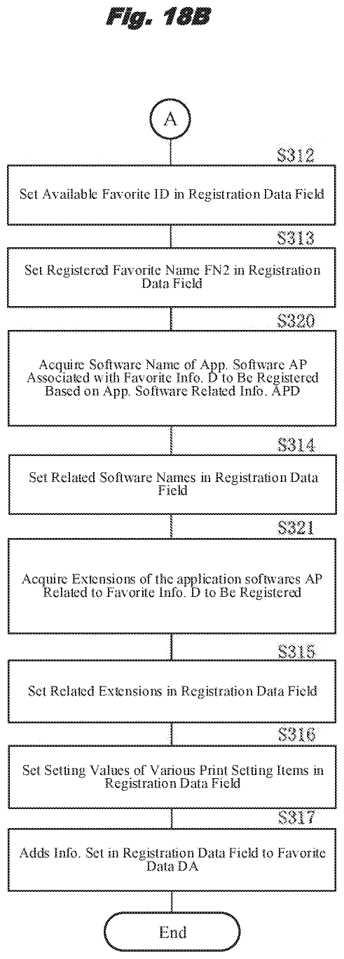

FIGS. 18A and 18B illustrate an operation example of a registration process of a favorite information D in the printer driver PDB. The operating system OS or an application software AP calls the printer driver PDB, and thereby, a process starts.

Processes of S301-S311 are the same as those of the above embodiment. Then, the registration part 164B of the printer driver PDB sets an available favorite ID in the registration data field (S312), and sets the registered favorite name FN2 in the registration data field (S313).

Next, the registration part 164B acquires the software name of the application software AP associated with the favorite information D to be registered based on the application software related information APD (S320). Specifically, based on the application software AP that is associated with the favorite information D to be registered in S307, the registration part 164B uses the application software related information APD to acquire the software name of another application software AP related to the application software AP, and thereby, acquires the software names of the application softwares AP associated with the favorite information D to be registered. In this execute, as illustrated in FIG. 15, “DDD” which is the software name of the application software AP (application software AP2) that is being executed is associated with “EEE” which is the software name of the application software AP related to the application software AP2. As a result, the registration part 164B acquires the software names “DDD” and “EEE” of the application softwares AP associated with the favorite information D to be registered.

Next, the registration part 164B sets the related software names in the registration data field (S314). Specifically, the registration part 164B sets the related software names (“DDD” and “EEE” in this example) acquired in S320 in the registration data field.

Next, based on the information managed by the operating system OS, the registration part 164B acquires the extensions of the application softwares AP related to the favorite information D to be registered (S321). In this example, the registration part 164B acquires, from the operating system OS, the extension of the application software AP2 of which the software name is “DDD” and the extension of the application software AP of which the software name is “EEE.” As a result, the registration part 164B acquires the related extensions “ddd1” and “eee1.”

Next, the registration part 164B sets the related extensions in the registration data field (S315). Specifically, the registration part 164B sets the extensions (“ddd1” and “eee1” in this example) acquired in S321 in the registration data field.

Next, the registration part 164B sets the setting values of the various print setting items in the registration data field (S316). Then, the registration part 164B adds the information set in the registration data field to the favorite data DA (S317).

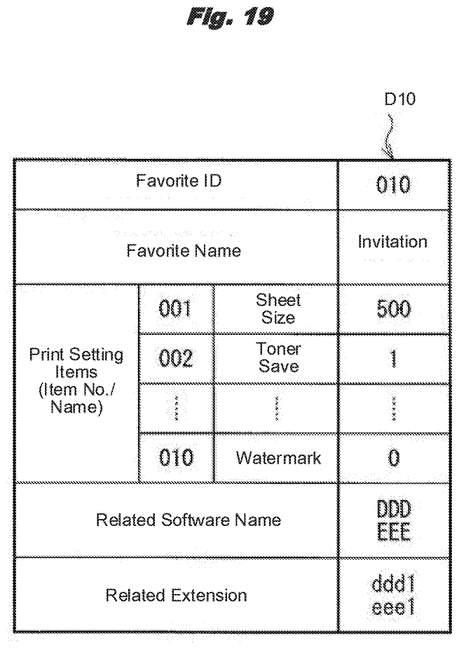

FIG. 19 illustrates an example of the registered favorite information D (favorite information D10). The favorite information D10 is a newly added favorite information D. The favorite ID is “010,” the favorite name is “Invitation,” the related software names are “DDD” and “EEE,” and the related extensions are “ddd1” and “eee1.”

As a result, this sequence is terminated.

In this way, in image forming system 3, a favorite information D is registered by associating the favorite information D with the application software AP2 that is being executed and other application softwares AP related to the application software AP2. Therefore, for example, when a print process is performed, the number of options of favorite informations D that are likely to be used by a user can be increased, and thus, user convenience can be improved.

### Fifth Modified Embodiment

In the above embodiment, in a print process, the acquisition part 162 respectively compares the related software name and the related extension of each of the multiple favorite informations D included in the favorite data DA with the software name N1 and the print target file extension E1 of the application software AP1 that is being executed. However, the present invention is not limited to this. Instead of this, for example, it is also possible that the acquisition part 162 compares the software name of each of the multiple favorite informations D with the software name N1 of the application software AP1 without comparing the extensions. Further, for example, it is also possible that the acquisition part 162 compares the related extension of each of the multiple favorite informations D with the print target file extension E1 without comparing the software names.

### Sixth Modified Embodiment

In the above embodiment, one or more favorite informations D among the multiple favorite informations D are preferentially displayed. However, the present invention is not limited to this. In the following, the present modified embodiment is described in detail.

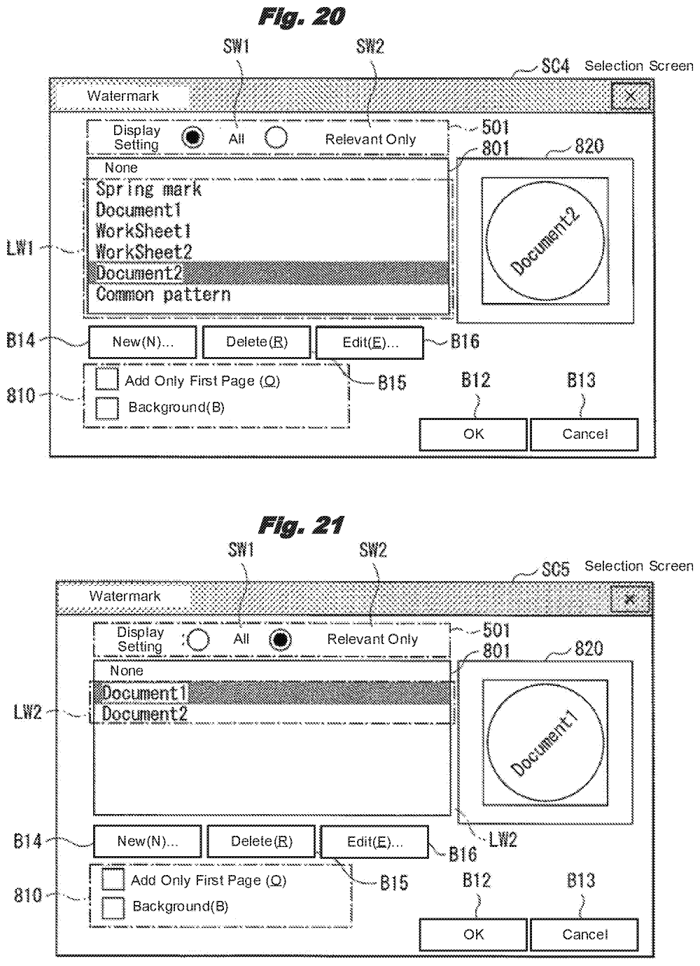

FIGS. 20 and 21 illustrate an example of selection screens SC4, SC5 for selecting a watermark. The selection screens SC4, SC5 are called, for example, from the print setting screen SC1. The selection screens SC4, SC5 each have a display setting field 501, a “Watermark Name” field 801, an image field 820, an OK button B12, a cancel button B13, a new button B14, a delete button B15, an edit button B16, and an option field 810. The “Watermark Name” field 801 is a field for displaying a display list LW showing selectable watermark names and for receiving a selection operation from a user. The image field 820 is a field for displaying a print image of a watermark selected by a user in the display list LW. The OK button B12 is a button for confirming set information. The cancel button B13 is a button for performing a process of discarding an input operation and returning to a previous screen. The new button B14 is a button for performing a process of newly generating watermark setting information. The delete button B15 is a button for performing a process of deleting a watermark. The edit button B16 is a button for performing a process of editing watermark setting information. The option field 810 is, for example, a field for receiving a selection operation of a display condition of a watermark.

In the example in FIG. 20, a radio button SW1 in the display setting field 501 is selected. As a result, the display list LW (display list LW1) includes watermark names of all registered watermarks. Further, in the example of FIG. 21, a radio button SW2 of the display setting field 501 is selected. As a result, the display list LW (display list LW2) includes watermark names of watermarks associated with the application software AP that is being executed among all the registered watermarks.

In this example, in a print process, based on the application software that is being executed, one or more watermarks among multiple registered watermarks are preferentially displayed using the display list LW. Therefore, a user can select a watermark in a short time and easily, and thus, user convenience can be improved.

### Other Modified Embodiments

Further, two or more of these modified embodiments may be combined.

In the above, the present technology has been described by illustrating an embodiment and several modified embodiments. However, the present technology is not limited to these embodiments and the like, and various modifications are possible.

In the above embodiment, one or more favorite informations among the multiple favorite informations included in the favorite data DA are selected using a software name of each application software. However, the present invention is not limited to this. Any information about an application software may be used. Specifically, for example, an executable file name of an application software may be used. In this case, for example, in the attribute information Y included in the favorite data DA, an executable file name is used in place of the related software name.

What is claimed is:

1. A printer driver causing a processor to perform:
a registration process in which correspondence information is generated by registering each of multiple preset informations in association with a file attribute information;
an acquisition process in which a first file attribute information of a print target file, which is opened by an application software that is being executed, is acquired; and
a display control process in which a control is performed such that, based on the first file attribute information and the correspondence information, one or more preset informations among the multiple preset informations are displayed in an easy-to-select display form.

2. The printer driver according to claim 1 wherein
the display control process includes a process in which a control is performed such that the one or more preset informations among the multiple preset informations are selected wherein the one or more preset informations is defined as the selected present informations, and the selected preset informations are displayed.

3. The printer driver according to claim 1 wherein
the display control process includes a process in which a control is performed such that the multiple preset informations are sequentially arranged and displayed from the one or more preset informations.

4. The printer driver according to claim 1 wherein
the display control process includes a process in which the one or more preset informations are selected by comparing the first file attribute information with the multiple file attribute informations that respectively correspond to the multiple preset informations included in the correspondence information.

5. The printer driver according to claim 1 wherein
the acquisition process includes a process in which, based on the first file attribute information, a file attribute information related to the first file attribute information is generated, and
the display control process includes a process in which a control is performed such that, based on the file attribute information generated by the acquisition process, the first file attribute information and the correspondence information, the one or more preset informations among the multiple preset informations are displayed in an easy-to-select display form.

6. The printer driver according to claim 1 further causing the processor to perform an input process in which a user operation is received, wherein
the display control process includes a process in which a control is performed such that, based on the input process, the one or more preset informations or the multiple preset informations are selectively displayed.

7. The printer driver according to claim 1 further causing the processor to perform an input process in which a user operation is received, wherein
the registration process includes a process in which, based on the input process, a second file attribute information is acquired, and one preset information is registered in association with the second file attribute information.

8. The printer driver according to claim 1 wherein
the registration process includes a process in which a second file attribute information of a processing target file of an application software that is being executed is acquired, and one preset information is registered in association with the second file attribute information.

9. The printer driver according to claim 7 wherein
the registration process includes a process in which, based on the second file attribute information, a file attribute information related to the second file attribute information is generated, and the one preset information is registered in association with the generated file attribute information and the second file attribute information.

10. The printer driver according to claim 1 wherein
the file attribute information includes at least either information about an application software or information about a file format.

11. The printer driver according to claim 1 wherein
the acquisition process includes a process in which, based on meta information that the print target file possesses, the first file attribute information is acquired.

12. The printer driver according to claim 1 wherein
each of the multiple preset informations is a favorite setting information including setting values of multiple print setting items.

13. The printer driver according to claim 1 wherein
each of the multiple preset informations is an information about a watermark.

14. A recording medium on which a printer driver is recorded, the printer driver causing a processor to perform:
a registration process in which correspondence information is generated by registering each of multiple preset informations in association with a file attribute information;
an acquisition process in which a first file attribute information of a print target file, which is opened by an application software that is being executed, is acquired; and
a display control process in which a control is performed such that, based on the first file attribute information and the correspondence information, one or more preset informations among the multiple preset informations are displayed in a selectable display form.
